(19) United States
(12) Patent Application Publication
(10) Pub. No.: US 2023/0149888 A1
(43) Pub. Date: May 18, 2023

(54) TUBULAR REACTOR WITH MIXING MEANS

(71) Applicant: AUTICHEM LTD, Appleton, Warrington (GB)

(72) Inventor: David Morris, Appleton, Warrington (GB)

(21) Appl. No.: 17/916,876

(22) PCT Filed: Apr. 7, 2021
(86) PCT No.: PCT/EP2021/058993

§ 371 Date: Oct. 4, 2022

(30) Foreign Application Priority Data
Apr. 8, 2020 (GB) 2005191.8

(51) Int. Cl. B01J 19/18; B01F 23/234; B01F 27/1125; B01F 27/115; B01F 27/73; B01F 31/445; B01F 31/44; B01J 10/00; B01J 14/00; B01J 19/00

(52) U.S. Cl. CPC B01J 19/1812; B01F 23/2342; B01F 27/11252; B01F 27/1155; B01F 27/73; B01F 31/445; B01F 31/449; B01J 10/007; B01J 14/005; B01J 19/0066; B01J 2219/00094; B01J 2219/00481; B01J 2219/00761; B01J 2219/00779; B01J 2219/1943

(57) ABSTRACT

A process and apparatus wherein a process material comprising two or more distinct phases are fed continuously to a tubular reactor containing an agitator wherein as the phases flow along the reactor the agitator displaces at least part of a first phase from its natural position to within a second phase where it is distributed within the second phase by the agitator and the agitator is designed to allow the first phase that is distributed within the second phase to flow naturally back towards its natural distinct position within the reactor as the phases pass through the reactor, useful for mixing and/or reacting liquid/liquid; gas/gas and liquid/gas mixtures as well as solid liquid mixtures.

The present invention relates to a continuous mixing process which may include reactions and to tubular reactors that involve the mixing of two or more phases; in particular immiscible phases. The reactors of the invention may be employed simply to produce a mixture of the phases, which may or may not be homogeneous. Alternatively in addition to the mixing of the phases a reaction between the phases may occur as the materials mix and flow through the reactor. The invention improves the interaction of the phases and provides improved mass and heat transfer between the phases leading to increased reaction and/or mixing efficiency.

Tubular reactors are well known and are reactors in which process material flows continuously along the length of the reactor. Typically agitators or stirrers are provided within the reactor along its length to enhance the mixing and perhaps reaction of the materials as they flow through the reactor. Various designs are known for the internals and the internal configuration of tubular reactors aimed at enhancing the mixing and reaction of materials.

The reactors of this invention can be used to mix and optionally react two or more phases; the phases may be liquid, gaseous or solid and/or may comprise particles and/or waves. The invention is however particularly useful to process two or more liquid phases, two or more gaseous phases or a system including at least one liquid phase and at least one gaseous phase. A solid phase may also be included but when included the solid should be in a finely divided state and/or be immobilised by adhesion to the reactor body and/or to an agitator or stirrer. When a particle and/or wave phase is included it is preferably present as a substantially regular flow of particles and/or waves which may comprise ions, electrons or photons as may be used in electrochemical or photochemical reactions.

The ideal flow condition in a tubular reactor is “plug flow”. In order to obtain a uniform homogenous output from a tubular reactor it is desirable that the process fluid flows through the reactor in a manner as close to plug flow as possible as this ensures that all the reactants are subjected to substantially the same sets of conditions as they pass through the reactor. In practice, ideal (100%) plug flow does not occur as factors like wall friction between the reactor inner wall and the process material, mixing and diffusion affect the velocity profile of the process material along the reactor. The ability to maintain reasonably good plug flow, however, can have significant benefits. Where yield and/or quality of product is sensitive to reaction time, good plug flow permits precise control of residence time within the reactor. Plug flow also results in greater separation between reacted and unreacted material. This is desirable for reactions where reaction rate is affected by reactant concentration.

Flow in a manner that is as near to plug flow as possible is important in good continuous flow processes to ensure a consistent residence time of process material within the reactor and to reduce the variabilities in the product. It is however also important that the reactants are well mixed and are uniformly mixed in order to optimise the speed and yield of the particular reaction. Accordingly the ideal conditions in a continuous flow reactor are that the axial flow (in the direction of the axis of the reactor) of the reactants is or approaches plug flow whilst the flowing plug is subjected to efficient radial mixing. Although these ideal conditions may not be attainable the present invention provides a reaction system that moves the conditions in a continuous reactor nearer to this ideal situation.

Mixing is important, as it is instrumental in reactions in bringing reactants together and maintaining good energy balance and temperature control. If good plug flow conditions are to be sustained, product mixing should be limited to the mixing of materials having the same time duration in the reactor (radial mixing). The present invention relates to improvements in or relating to reactors and/or mixers and in particular to reactors through which process materials flow continuously. In particular the invention relates to the provision of dynamic mixing or agitation within reactants as they pass along the length of a reactor. The reactor with which the invention is concerned is preferably tubular, it may be single stage or multistage and the stages may be in series or in parallel. Furthermore the reactor may be horizontal, vertical, inclined or a combination thereof.

Mixing in traditional batch reactors and/or mixers is predominantly achieved by mechanically stirring the process contents. Traditionally pitched and or curved blades are employed to pump the process fluid against the vessel bottom and vertically upwards. Vertical baffles are often incorporated close to the vessel walls that push the fluid towards the centre of the vessel. The purpose of these mixing arrangements is to ensure that the entire contents of the vessel are thoroughly mixed. Such mixing methodologies do not ideally translate to continuous flow processes however, where plug flow conditions are desirable. Flow reactor systems are sometimes built using continuously stirred tank reactors (CSTRs). These typically employ batch reactor mixing methodologies and as such do not provide a true plug flow system.

Most reactions require temperature control and reactors or mixers are frequently provided with a heat transfer surface backed by a reservoir of heat transfer fluid in a heat transfer jacket.

The present invention is an improvement to the flip-flop agitator system we described in GB Patent Application 2545927A.

The invention therefore provides a process wherein a process material comprising two or more distinct phases are fed continuously to a tubular reactor containing an agitator wherein as the phases flow along the reactor the agitator displaces at least part of a first phase from its distinct position to within a second phase where it is distributed within the second phase by the agitator and the agitator is designed to allow the first phase that is distributed within the second phase to flow naturally back towards its original distinct position within the reactor as the phases pass through the reactor.

The invention further provides a reaction vessel through which process material comprising at least two phases usually liquids although a liquid can be processed in conjunction with a gas an immobilised or suspended solid flow or a flow of particles or waves such as ions, electrons or photons in a continuous manner entering the reaction vessel through an inlet and the product leaving the reaction vessel via an outlet wherein an agitator is provided inside the vessel which is capable of rotational or reciprocal movement through an arc and the agitator is shaped to capture material from a first phase in its preferred situation to transfer the material to within a second phase where it is distributed within the second phase and subsequently allowed to pass through the agitator back to its original situation.

The invention further provides a series of agitator designs which can be utilized to improve the efficiency of specific processes. Typically these include liquid-liquid reactions, gas-liquid reactions, reactions containing suspended solids (slurries) or immobilised solids, reactions driven by the introduction of particles or waves and any combination of gases—liquids, solids and slurries or particles or waves. In a further alternative embodiment reactants in the form of particles and/or waves such as electrons, ions and photons and light waves such as ultra violet light may be introduced to the process; here this invention can overcome the problem with conventional systems that the electrons ions and photons can be retained in the surface layer of the process material.

In a preferred embodiment the reactor is a tubular reactor and the agitator comprises a probe within the tubular reactor extending substantially along the length of the reactor. In a further preferred embodiment of the invention, apertures, through holes, or slots (at least one but not limited in number) are cut or formed into the body of the agitator. These penetrations permit and encourage radial flow of the process fluid through the agitator body and provide a mixing system that is close to plug flow conditions and is scalable from small laboratory systems to much larger industrial scales. Furthermore in previous systems where process material phases are current high shear is required. This is traditionally created by pumping the process material using a high speed agitator. This often damages delicate cells, or crystals and catalytic solids however. However the present invention allows the exploitation of the natural transfer phenomena (such as buoyancy, gravity, reflection and refraction) of the dissimilar process material phases and apertures provided in the body of the agitator can provide effective shear at much lower speeds.

The sizes of the through penetrations (apertures, holes and slots) in the agitator can vary in size for example ranging from 0.0000001 mm to 1,000 mm. The incorporation of meshes, micro slots and perforations further enhances the closeness and concentration of the penetrations within the agitator body.

The use of these penetrations within the body of the agitator, allow gases, liquids, solids and/or particles and/or waves to pass through the agitator in the radial plane of the reactor. Where gases and liquids, or immiscible liquids are components of the process material these are broken down by the agitator into smaller conglomerations thus increasing the mass transfer and mixing between the phases.

It is preferred that the agitator has a convex and/or concave profile as is described in GB Patent Application 2545927. This shaping of the agitator enables relatively large volumes (relative to the capacity of the reactor) of each distinct phase of the process material, to be transported radially within the reactor tube from its natural situation to its unnatural situation. For example if one phase is a gas and the other phase is a liquid the natural situation of the gas would be above that of the liquid and the natural situation of the liquid would be below that of the gas. The unnatural situation of the gas would be to be within the liquid and vice versa. A second example is if one phase is a liquid and the second phase is a photon emitted from a light source. In this instance the natural position of the liquid is to occupy the entire available volume of the reactor wherein it will flow in a longitudinal direction along the length of the reactor at a rate determined by the throughput. On leaving the source photons travel in waves directed at the reactor. The Stark-Einstein or photoequivalence law and the Bunsen-Roscoe law will typically limit the attainable position of each photon to an area within a thin film of the liquid adjacent to the point at which the photon enters the liquid.

Accordingly in this instance high conversion rates of the interaction of the photons with the liquid can be achieved by repositioning the liquid in the radial plane within the reactor to a new unnatural position as can be achieved by the present invention.

Using the apparatus of the present invention in the tipping point of the agitator rotation, natural forces (gravity, buoyancy, reflection and refraction) transport the process materials to and from their natural situation within the reactor tube. The continued movement of the agitator encourages the transportation of the process materials through the apertures, holes or slots, breaking down the process material phases into multiple smaller conglomerations and thus greatly increasing the mass transfer between the phases. Whilst with traditional mixing methodology, this is only achievable at high mixing speeds, the method of this invention achieves good mass transfer at low speed mixing, thus eliminating damage to delicate process materials, saving energy and greatly reducing the heating of the process materials which can occur with highly energetic mixing. Additionally, when the agitator is convex the convex edge of the agitator moves radially and in close proximity to the heat transfer surface of the reactor tube wall, thus creating radial turbulence across the heat transfer surface and promoting the heat transfer coefficients.

The movement of the agitator can be effectively operated by a number of different motive forces, including, but not limited to, compressed gases (e.g. air or nitrogen), electricity and hydraulics. These are used to power actuators, including hydraulic motors, electric motors, pneumatic motors and pneumatic actuators that turn the actuator in the desired action via a shaft and coupling mechanism. The agitator driveshaft can be either coupled to the actuator directly (or via a gear or a belt or a chain or a hydraulic fluid or a compressible gas) through a seal or magnetically coupled.

The sizes and shapes of the agitators used in this invention may be chosen according to the size and shape of the reactor and/or the nature of the reaction or mixing process for which the reactor is to be used. The sizes and shapes of the agitator may be varied within a tubular reactor according to the reaction or mixing that is being performed and this can increase the flexibility and use of the invention. Indeed, for some processes it is advantageous to have multiple changes of volume of process material within the tubular reactor along the length of the agitator and this may be accomplished by changing the volume within the reactor that is occupied by the agitator. Where this method is deployed, the residence time of the process material changes as the plug flow passes through the system without having to alter the feed rate. However we have established a number of preferred features for the agitator designs for example an agitator with sharp corners and also having a rectangular cross section with the surfaces changing from convex to concave in design provides particularly good mixing generating radial turbulence in the process fluid. We have also found that good mixing is achieved if the agitator occupies from 10% to 99%, preferably 25% to 90% of the cross sectional area of the tube within which it is used.

In an alternative embodiment reactants such as catalysts and other solids may be provided within the agitator where they maybe immobilised and held captive.

In one embodiment of the invention the agitator is driven by a pneumatic motor first in the clockwise direction, then stopped and driven in the counter clockwise direction (or vice versa). This action is repeated multiple times for time periods that are determined according to the nature of the process materials and the speed at which they pass through the reactor in order to give the desired mixing effect.

In a preferred embodiment of the invention apertures which vary in sizes along the longitudinal length of the agitator are deployed to vary the residence time of the process material.

In a more preferred embodiment of the invention apertures within the body of the agitator are used to mix immiscible process materials by exploiting the natural buoyance discrepancies of the process materials.

In an additional preferred embodiment of the invention the reflection and refraction properties of the apertures and agitator body material are used to mix immiscible process materials by exploiting the natural buoyance discrepancies of the process materials and additionally exploiting the natural reflection and refraction properties of the reactor and agitator body materials.

The type of agitator drive system employed will ultimately depend on each particular process or unit operation. In most circumstances however a system wherein the speed of the agitation is between 0.001 and 100 cycles per second with the agitator travelling at speeds between 1 and 10000 rpm, will fulfil most operational needs.

In theory there are no limits to the length and diameter of the tubular reaction vessel. There are however a number of practicalities that will ultimately determine the design sizes and length to diameter ratio of each particular system. The capacity required for research and development may for example be smaller than that of reactors useful with larger reactors required for commercial operation. Other factors include but are not limited to, consideration of the kinetics of the reaction in question and other process needs, consideration of the mechanical construction in relation to operational pressure, temperature and materials of construction, consideration of the erection, operation and maintenance of the equipment and consideration of the cost of construction and installation. Tubular reactors having a tubular diameter ranging from 10 mm to 5000 mm may be employed. The length of the vessel is similarly constrained and in practice vessels with lengths of from 0.05 to 20 meters being preferred. Where the process and reaction kinetics necessitate much longer residence times however multiple shorter vessels may be employed in series and or in parallel to create systems that can be several km in length. In such circumstances the costs of construction and installation may be limiting factors.

The possible ratios of tube length to tube diameter are again in theory limitless and as yet we have not established any technical preference for a tube diameter to length ratio. From a cost perspective however it is most economical to fabricate the equipment using off the shelf materials and materials such as steel are often supplied in standard lengths and in a range of standard diameters. From a heat transfer perspective smaller diameter vessels are preferred as they provide the system with a greater surface to volume ratio that will consequently add or remove heat from a process more effectively than a larger diameter tube with a relatively smaller heat transfer area per unit volume of process fluid.

The residence time within the reactor for any given process can be described as the amount of time needed to complete the reaction and/or mixing to its best attainable yield using economic and sustainable methods. Each different process or unit operation in a reactor will require a different residence time. Consequently there is no one size fits all circumstances and the ideal length and diameter of the vessel will vary from process to process.

The reactor of this invention may be used for exothermic reactions or for reactions which require heating to improve reaction speed and yield. Accordingly the reactor may be provided with an external heating or cooling jacket through which a temperature control fluid can pass. In some instances the jacket may be divided up into sections to provide different heating or cooling effects along the length of the tubular reactor. In an alternative embodiment heating/cooling can additionally be applied internally by flow channels cut within the body of the agitator shaft.

For example, where highly exothermic reactions are operated the energy released is significant and it is desirable in such circumstances to remove the energy produced as efficiently and as quickly as possible. In these circumstances the ratio of heat transfer area to process volume is an important variable and long small diameter tubes are often employed. In such a reaction system the flow velocity of the process fluid and the energy exchange rate of the heat transfer system substantially are constant along the entire length of the reactor.

However, the amount of energy released from the reaction may be very different at the start of the reaction to that at the end of the reaction and the lack of control of the process flow velocity/residence time and energy exchange rate can result in a poor yield and a heterogeneous product. These problems are addressed by the present invention. For example the outside diameter of the agitator relative to the internal diameter of the tubular vessel may be adjusted, usually reduced, along the length of the reactor. Alternatively or additionally the displacement volume of the agitator can be varied along the length of the reactor. In these embodiments the relative ratio of heat transfer surface area to process volume is adjusted. We have also found that good mixing is achieved if the agitator occupies from 10% to 99% of the cross sectional area of the tube within which it is used.

The change in agitator diameter along the length of the reactor can be either a tapered change or a step change where there is at least 1 step change but no more than 10000, typically no more than 100, step changes in diameter.

To ensure good heat transfer coefficients are maintained one or more convex mixing elements can rotate in a radial fashion in close proximity to the reactor tube heat transfer surface.

The present invention is illustrated by reference to the accompanying Figures which show various agitator designs for use in the present invention.

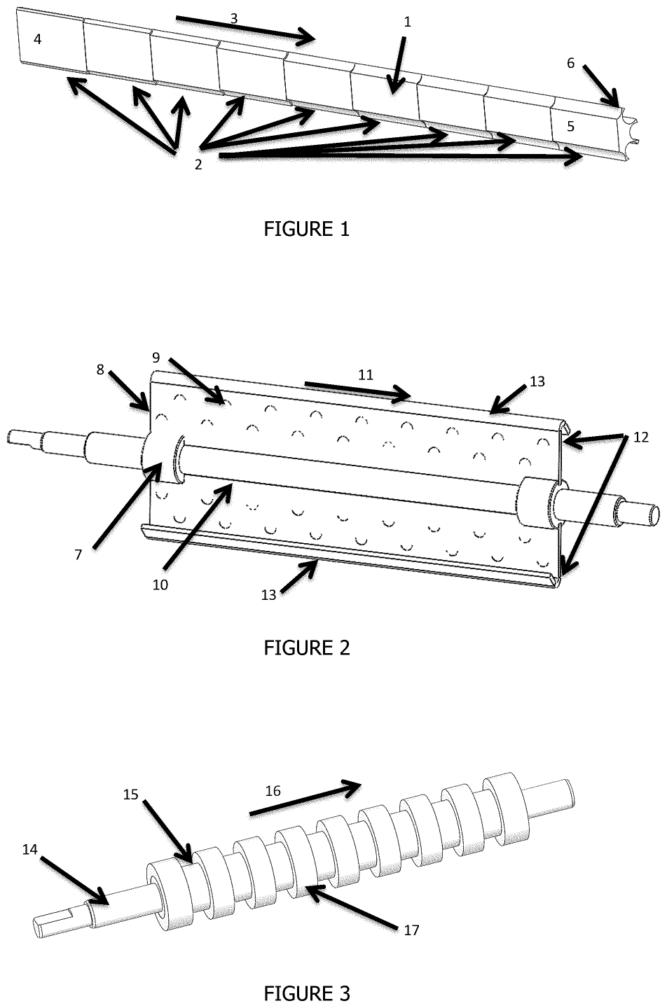

FIG. 1 shows an agitator (1) wherein one or more longitudinal channels (2) are deployed to change the residence time of the process material. A process fluid can flow as indicated by arrow (3). In this way the process fluid has a short residence time in section (4) and a progressively increasing residence time as it passes along the reactor to section (5) giving control of the temperature according to the degree of reaction. Concave mixing elements (6) promote good heat transfer coefficients.

FIG. 2 shows an agitator (7) with multiple mixing elements (8) wherein radial penetrations (9) and longitudinal penetrations (10) reduce the conglomeration size of the process material phases flowing in the direction of the arrow (11) while the concave profiles (12) transports the process phase material to its unnatural situation and the convex profiles (13) promote good heat transfer coefficients.

FIG. 3 shows an agitator (14) with multiple radial channels (15) wherein vortices generated within the individual radial channels reduce the conglomeration size of the process material phases flowing in the direction of the arrow (16) and transport the process phase materials to their unnatural situation and the convex profiles (17) promote good heat transfer coefficients.

For some process applications this technology may be operated in part or as a whole system as a batch or loop reactor or bio-reactor. For example a flow crystallization system that filters out undersized particles and reintroduces them to the system either at the start of the reactor or part way along the reactor length. Or a bioprocessing system wherein algae is used to sequestrate carbon dioxide.

The reactors of this invention may be made from a range of materials depending on the nature of the reactants. However glass (e.g. borosilicate and silica quartz), ceramics (e.g. Zirconia and Silicon Carbide), plastics (e.g. PTFE, PFA, PVDF, Nylon and Peek), alloy steel (e.g. Alloy C276, Tantalum, Titanium and stainless steels), steel, glass lined (enamelled) steel and plastic lined steel have been found to be particularly useful.

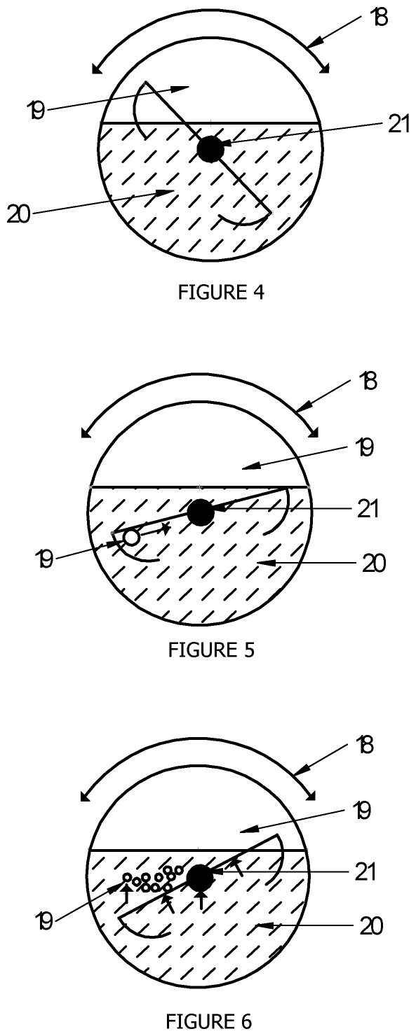

FIGS. 4, 5 and 6 are schematic cross sectional illustrations through a reactor tube fitted with an agitator and showing the operation of a reactor of the present invention wherein the process material comprises a gas phase and a liquid phase.

FIG. 4 shows the reactor in its starting position, the arrows (18) showing the reciprocal motion of the agitator (19) is a gas phase and (20) is a liquid phase and (21) is the agitator provided with a convex profile at its ends. In this Figure both the gas and the liquid are in their natural situations.

FIG. 5 shows how as the agitator rotates it take some of the gaseous phase (22) with it into the liquid phase.

The agitator is provided with a series of small holes or penetrations (not shown) and FIG. 6 shows how the element of the gaseous phase (22) is broken up by the force of the agitator and they pass back through the holes in the agitator due to the natural buoyancy and tendency to revert to their original situation.

Although this is shown just at the initial location of the reactor this mechanism will be repeated along the reactor as the process material comprising the two phases flows along the reactor thereby enabling the phases to interact and produce the desired product at the outlet of the reactor which may be a mixture of the phases or the reaction product of the phases.

1. A process wherein a process material comprising two or more distinct phases are fed continuously to a tubular reactor containing an agitator, wherein as the phases flow along the reactor, the agitator displaces at least part of a first phase from its distinct position to within a second phase where it is distributed within the second phase by the agitator, and the agitator is designed to allow the first phase that is distributed within the second phase to flow naturally back towards its original distinct position within the reactor as the phases pass through the reactor.

2. The process according to claim 1, in which apertures, through holes, or slots are provided in the agitator which allow gases, liquids, and/or solids to pass through the agitator in a radial plane of the reactor.

3. The process according to claim 1, wherein components of the phases are broken down by the agitator into smaller conglomerations thus increasing the mass transfer and mixing between the phases.

4. The process according to claim 1, wherein at a tipping point of rotation of the agitator, natural forces transport the phases back to their natural situation within the reactor tube.

5. The process according to claim 4, in which the natural forces are selected from gravity and buoyancy.

6. The process according to claim 4, in which the natural forces are selected from reflection and refraction.

7. (canceled)

8. (canceled)

9. The process according to claim 1, in which the agitator is driven by a pneumatic or electric or hydraulic motor or actuator first in a clockwise direction, then stopped and driven in a counter clockwise direction, or vice versa.

10. (canceled)

11. A reaction vessel through which process material comprising at least two phases flow in a continuous manner entering through an inlet and product leaving via an outlet, wherein an agitator is provided inside the vessel which is capable of rotational or reciprocal movement through an arc, and the agitator is shaped to capture material from a first phase in its preferred situation to transfer the material to within a second phase where it is distributed within the second phase and subsequently allowed to pass through the agitator back to its original situation.

12. The reaction vessel according to claim 11, in which the phases comprise liquids optionally in conjunction with a gas or a suspended solid.

13. The reaction vessel according to claim 11, wherein the reaction vessel is a tubular reactor.

14. The reaction vessel according to claim 13, in which the agitator comprises a probe within the tubular reactor extending substantially along a length of the reactor.

15. The reaction vessel according to claim 14, in which penetrations comprising apertures, through holes, or slots are cut or formed into a body of the agitator.

16. The reaction vessel according to claim 15, in which the penetrations permit and encourage radial flow of the process fluid through the agitator body and provide a mixing system that is close to plug flow conditions along the vessel.

17. (canceled)

18. The reaction vessel according to claim 11, wherein the agitator has a convex and/or concave profile.

19. The reaction vessel according to claim 11, wherein the agitator occupies from 10% to 99% of the cross sectional area of the tube within which it is used.

20. (canceled)

21. (canceled)

22. The reaction vessel according to claim 11, wherein flow channels are cut within a body of a shaft of the agitator for an application of heating/cooling.

23. A reaction vessel according to claim 11, wherein the reaction vessel is a tubular vessel, and wherein an outside diameter of the agitator relative to an internal diameter of the tubular vessel is varied along a length of the reaction vessel.

24.-28. (canceled)

29. The reaction vessel according to claim 19, wherein the agitator occupies from 25% to 90% of the cross sectional area of the tube within which it is used.
